(19) United States
(12) Patent Application Publication
(10) Pub. No.: US 2009/0011518 A1
(43) Pub. Date: Jan. 8, 2009

(54) Device and Method for Detection of Fluorescence Labelled Biological Components

(75) Inventor: Stellan Lindberg, Forslov (SE)

Correspondence Address: BUCHANAN, INGERSOLL & ROONEY PC, POST OFFICE BOX 1404, ALEXANDRIA, VA, 22313-1404, US

(73) Assignee: HemoCue AB, Angelholm (SE)

(21) Appl. No.: 12/223,719

(22) PCT Filed: Mar. 23, 2007
(86) PCT No.: PCT/SE2007/000283

§ 371 Date: Aug. 7, 2008

(30) Foreign Application Priority Data
Mar. 28, 2006 (SE) 0600687-8

(51) Int. Cl. G01N 21/64

(52) U.S. Cl. 436/172; 422/82.08

(57) ABSTRACT

A sample acquiring device for detection of biological components in a liquid sample is provided comprising a measurement cavity for receiving a liquid sample, wherein the measurement cavity has a predetermined fixed thickness, and a reagent, which is arranged in a dry form inside the measurement cavity. The reagent comprises a fluorophore conjugated molecule.

### TECHNICAL FIELD

The present invention relates to a sample acquiring device, a method and a system for detection and volumetric enumeration of fluorescence labelled biological components in a liquid sample.

### BACKGROUND ART

When analysing a biological sample, such as a cell sample, it is desirable to be able to identify the different components of the sample, e.g. the different types of cells present. These different components display respective molecular structures, such as cell surface markers, by which the components may be distinguished. By using fluorophore conjugated molecules arranged to bind to these molecular structures the biological components may be fluorescently labelled. A few techniques for detecting and analysing fluorescently labelled components, mainly cells, are known in the art, predominantly the flow cytometry and fluorescence microscopy techniques.

In flow cytometry, suspended fluorescence labelled cells are passed, one by one, through a flow channel in front of a laser beam and the fluorescence of several different wavelengths can be measured, as well as the forward and orthogonal light scatter. Thus the labelling of several different fluorophores, as well as the size and granularity of the cells may be analysed. Flow cytometry methods are disclosed in e.g. U.S. Pat. No. 3,826,364, U.S. Pat. No. 4,248,412 and U.S. Pat. No. 5,047,321.

Fluorescence microscopy is generally conducted by irradiating a fluorescent sample to be studied, usually smeared onto a microscope slide, with electromagnetic radiation of a specific shorter wavelength, causing fluorophores in the sample to absorb said radiation and subsequently emit electromagnetic radiation of a specific longer wavelength. The emitted radiation is detected using a microscope equipped with a chromatic filter, or an equivalent monochromator, which essentially only allows the emitted longer wavelength radiation to pass.

In U.S. Pat. No. 4,125,828 and US 2006/0017001 are disclosed fluorescence microscopes and methods for detecting a fluorescent sample which has been smeared onto a microscope slide.

In U.S. Pat. No. 5,932,428 is disclosed an assay and sample mixture for the enumeration of fluorescently stained target components of a blood sample by an imaging instrument. In one aspect of U.S. Pat. No. 5,932,428, whole blood is mixed with a dried down fluorescently labelled antibody and a zwitterionic detergent, after which the blood mixture is drawn into a scan capillary. The filled capillary is scanned using a laser beam which is narrowed in the form of a Gaussian waist that intersects the capillary. The laser thus illuminates a columnar region of the capillary that equals the diameter of the Gaussian waist times the depth of the lumen of the capillary and excites any fluorescent matter in this region. The fluorescence from this region is detected by a light detector. The laser then illuminates another region of the capillary, and the fluorescence of that region is also detected, etc. In this way a predetermined volume of the sample is scanned for fluorescence.

In US 2006/0024756 a device, method and algorithm for enumeration of fluorescently and magnetically labelled cells is disclosed. According to the disclosed method all cells are fluorescently labelled, but only the target cells are also magnetically labelled. The labelled cell sample is placed in a chamber or cuvet between two wedge-shaped magnets to selectively move the magnetically labelled cells to an observation surface of the cuvet. A LED illuminates the cells and a CCD camera captures the images of the fluorescent light emitted by the target cells. Cell labelling can take place in the cuvet or chamber used for analysis, or the sample is transferred to such a cuvet or chamber after sufficient time is allowed to permit cell labelling. The volume of the cuvet is known and is used to determine the absolute concentration of the target cells in the blood sample. However, this requires waiting until all the target cells have been magnetically moved to an observation surface before they can be detected and counted.

EP 0 422 708 discloses a device for use in chemical test procedures. The device comprises a cavity defined by two planar and parallel walls, one of which holds covalently immobilised antibodies and this or another wall holds dried, but not covalently immobilised, fluorescently labelled antibodies. The objective is to use the device for sandwich assays of an antigen which can bind to both the immobilised and the labelled antibodies. A liquid sample containing the antigen to be assayed is sucked by capillary force into the device, dissolving the labelled antibodies. The antigen is bound by the immobilised and also the labelled antibodies bind to the antigen, whereby fluorescently labelled antibodies are concentrated at the wall holding covalently immobilised antibodies. This wall is made of glass, or another light transmitting material, and has the ability to conduct light like an optic fibre or wave guide. The presence of antigen in the liquid sample is detected by measuring the light intensity at the edge of the wall, i.e. the light guided by the wall which emanate from the fluorescing antibodies present at said wall.

### SUMMARY OF THE INVENTION

It is an object of the invention to provide a simple analysis for detecting fluorescently labelled biological components of a liquid sample. According to one aspect of the invention it is an object to provide a simple analysis for volumetric enumeration of fluorescently labelled biological components of a liquid sample. It is a further object of the invention to provide a quick analysis without the need for complicated apparatuses or extensive sample preparations.

These objects are partly or wholly achieved by a sample acquiring device, a method and a system according to the independent claims. Preferred embodiments are evident from the dependent claims.

According to one aspect, the present invention thus relates to a sample acquiring device for detection of biological components in a liquid sample, said sample acquiring device comprising a measurement cavity for receiving a liquid sample, wherein the measurement cavity has a predetermined fixed thickness. The sample acquiring device also comprises a reagent, which is arranged in a dry form inside the measurement cavity, said reagent comprising a fluorophore conjugated molecule.

According to another aspect, the present invention relates to a method for detection of fluorophore labelled biological components in a liquid sample. The method comprises mixing a reagent comprising a fluorophore conjugated molecule with a liquid sample such that the fluorophore conjugated molecule binds to a specific molecular structure of a biological component in the liquid sample, introducing the liquid sample into a measurement cavity of a sample acquiring device, said measurement cavity having a predetermined fixed thickness; irradiating an area of the sample in the measurement cavity with electromagnetic radiation of a wavelength corresponding to an excitation wavelength of the fluorophore; and detecting fluorophore labelled biological components in the entire thickness of the measurement cavity, said detecting comprising acquiring a digital image of the irradiated area in the measurement cavity.

The sample acquiring device provides a possibility to directly obtain a sample of whole blood into the measurement cavity and provide it for analysis. There is no need for sample preparation. In fact, a blood sample may be sucked into the measurement cavity directly from a pricked finger of a patient. Providing the sample acquiring device with a reagent enables a reaction within the sample acquiring device which makes the sample ready for analysis. The reaction is initiated when the blood sample comes into contact with the reagent. Thus, there is no need for manually preparing the sample, which makes the analysis especially suitable to be performed directly in an examination room while the patient is waiting.

Since the reagent is provided in a dried form, the sample acquiring device may be transported and stored for a long time without affecting the usability of the sample acquiring device. Thus, the sample acquiring device with the reagent may be manufactured and prepared long before making the analysis of a blood sample.

The sample acquiring device of the present invention may thus easily and reproducibly be used by even an untrained person, and not necessarily in a regular standardised laboratory environment, as the sample acquiring device may form a ready-to-use kit where the sample inlet of the sample acquiring device only need to be moved into contact with the sample in order to provide sample in a form ready to be analysed.

Further, the fixed thickness of the measurement cavity provides a possibility to determine the count of biological components per volumetric unit of the liquid sample. Since the method is arranged to detect fluorophore labelled biological components in the entire thickness of the measurement cavity, it is possible to perform analysis of the liquid sample quickly. There is no need to await that the biological components of interest settle within the measurement cavity or are drawn to an observation surface.

The biological components of the liquid sample may be, e.g., eukaryotic cells, such as mammalian cells (e.g. leucocytes and platelets); bacteria; viruses; and macro molecules, such as DNA.

The liquid sample may be, e.g., a bodily fluid, such as undiluted whole blood, urine or spinal fluid; or a cell culture, such as a mammalian cell culture or a bacterial culture. The liquid sample may be an undiluted biological fluid which has not undergone any pre-treatment. Pre-treatment of a biological sample, such as dilution, centrifugation and lysing leads to a lower accuracy when relating enumerated target cells to the analysed volume. The more pre-treatment steps, the lower the accuracy of the enumeration. By not employing any type of pre-treatment before entering the sample into the ready-to-use sample acquiring device the method is simplified further.

It is thus possible to detect the presence or amount of, e.g., a specific cell type in a blood sample.

The sample acquiring device may comprise a body member having two planar surfaces to define said measurement cavity. The planar surfaces may be arranged at a predetermined distance from one another to determine a sample thickness for an optical measurement. This implies that the sample acquiring device provides a well-defined thickness to the optical measurement, which may be used for accurately determining the count of fluorophore labelled biological components per volumetric unit of the liquid sample. A volume of an analysed liquid sample will be well-defined by the thickness of the measurement cavity and an area of the sample being imaged. Thus, the well-defined volume could be used for associating the number of fluorophore labelled biological components to the volume of the sample such that the volumetric count of fluorophore labelled biological components is determined.

The measurement cavity preferably has a uniform thickness of 50-170 micrometers. A thickness of at least 50 micrometers implies that the measurement cavity does not force a liquid sample, such as a cell sample, to be smeared into a monolayer allowing a larger volume of liquid sample to be analysed over a small cross-sectional area. Thus, a sufficiently large volume of the liquid sample in order to give reliable values of the count of fluorophore labelled biological components may be analysed using a relatively small image of the cell sample. The thickness is more preferably at least 100 micrometers, which allows an even smaller cross-sectional area to be analysed or a larger sample volume to be analysed. Further, the thickness of at least 50 micrometers and more preferably 100 micrometers also simplifies manufacture of the measurement cavity having a well-defined thickness between two planar surfaces.

For most samples, e.g. a blood sample, arranged in a cavity having a thickness of no more than 170 micro-meters, the count of fluorophore labelled biological components, such as cells of a blood sample, is so low that there will be only minor deviations due to components being arranged overlapping each other. However, the effect of such deviations will be related to the count of fluorophore labelled biological components and may thus, at least to some extent, be handled by means of statistically correcting results at least for large values of the count of fluorophore labelled biological components. This statistical correction may be based on calibrations of the measurement apparatus. The deviations will be even less for a measurement cavity having a thickness of no more than 150 micrometers, whereby a simpler calibration may be used. This thickness may not even require any calibration for overlapping biological components.

Further, the thickness of the measurement cavity is sufficiently small to enable the measurement apparatus to obtain a digital image such that the entire depth of the measurement cavity may be analysed simultaneously. If a magnifying system is to be used in the measurement apparatus, it will not be simple to obtain a large depth of field. Therefore, the thickness of the measurement cavity would preferably not exceed 150 micrometers in order for the entire thickness to be simultaneously analysed in a digital image. The depth of field may be arranged to handle a thickness of the measurement cavity of 170 micrometers.

The digital image may be acquired with a depth of field at least corresponding to the thickness of the measurement cavity. This implies that a sufficient focus is obtained of the entire sample thickness such that the entire thickness of the measurement cavity may be simultaneously analysed in the digital image of the sample. Thus, there is no need to await that, e.g., cells settle in the measurement cavity, whereby the time for making an analysis is reduced. By choosing not to focus very sharply on a specific part of the sample, a sufficient focus is obtained of the entire sample thickness to allow identification of the number of fluorophore labelled biological components in the sample. This implies that a fluorescent component may be somewhat blurred and still be considered to be in focus of the depth of field.

The fixed thickness of the measurement cavity allows an analysis of a well-defined volume of the sample. In particular, an area of the measurement cavity is adapted to be imaged in order to provide analysis of a well-defined volume of the sample, whereby volumetric enumeration of a biological component in the sample may be obtained. The area being imaged together with the thickness of the measurement cavity provides a well-defined volume of the sample. By counting the number of labelled biological components within this static volume, the volumetric count of the biological components in the sample may be easily obtained. The volumetric count may be obtained by analysing a digital image of the volume. Thus, a volumetric count may be achieved without the need for passing a sample in front of an analyser, as is performed according to the flow cytometry principle.

The sample acquiring device may be provided with a reagent that has been applied to the surface solved in a volatile liquid which has evaporated to leave the reagent in a dried form.

It has been realised that the reagent is advantageously solved in a volatile liquid before being inserted into the measurement cavity. This implies that the liquid may in an effective manner be evaporated from the narrow space of the measurement cavity during manufacture and preparation of the sample acquiring device.

The reagent may preferably be solved in an organic solvent and more preferably be solved in methanol. Such solvents are volatile and may appropriately be used for drying the reagent onto a surface of the measurement cavity.

The reagent, including all its components, of the present invention is preferably dissolvable and/or suspendable in the liquid sample to be analysed, and is preferably intended to stay in solution/suspension throughout the analysis. Since, as stated above, the method is arranged to detect fluorophore labelled biological components in the entire thickness of the measurement cavity and there is no need to draw or immobilise the biological components of interest to an observation surface, there is also no need to immobilise, or in any other way avoid dissolution/suspension, of the reagent or any component of the reagent. On the contrary, using a dissolvable/suspendable reagent, preferably an easily dissolvable/suspendable reagent, facilitates mixing of the reagent with the liquid sample and accelerates any reactions between the reagent and the liquid sample including the biological component to be measured.

The reagent of the present invention comprises a fluorophore conjugated molecule. A fluorophore, or fluorochrome, is herein defined as a moiety of a molecule which causes the molecule to be fluorescent. A molecule is fluorescent if it emits electromagnetic radiation of a specific wavelength as a response to being subjected to radiation of a different wavelength.

Commonly used fluorophores, or fluorochromes, include e.g. fluorescein isothiocyanate (FITC), phycoerythrin (PE), peridinin chlorophyll protein (PerCP), allophyccocyanin (APC) and cyanin-5.5 (Cy5.5).

The fluorophore conjugated molecule is preferably arranged to bind to a specific molecular structure of a biological component. Examples of such molecules include, but are not limited to, ligands, receptors, antigens, antibodies and antibody fragments. Examples of antibody fragments are e.g. fragment antigen binding (Fab) and single chain fragment variable (scFv). Antibodies and antibody fragments are preferred as they are relatively easily obtained with affinity against all kinds of molecular structures, and many schemes for conjugating them with different kinds of fluorophores are known.

The molecular structure may be any specific molecular structure of a biological component, e.g., a cell surface marker, such as CD4 or CD8, or an intra cellular structure, such as DNA. A cell surface marker is herein defined as any molecular characteristic of the plasma membrane of a cell which is accessible from the outside of the cell, such as an antigen or epitope. This implies that any types of cells may be detected for any purpose, such as detecting and enumerating CD4+ cells for the sake of monitoring an HIV infection.

The amount of fluorophore conjugated molecule is preferably selected so that there is a sufficient amount to bind to the biological components. In order to ensure that essentially all targeted biological molecules are adequately labelled by the fluorophore conjugated molecules within reasonable time the fluorophore conjugated molecules need to be present in excess. There will however still be unbound fluorophore conjugated molecules in the mixed sample and it is desired that this unbound concentration is kept sufficiently low to keep down the background fluorescence when the sample is analysed. Thus, the fluorophore conjugated molecules should not be present in too large excess. The ratio of bound to unbound fluorophore conjugated molecules is dependent on the affinity between the fluorophore conjugated molecules and the biological component, and the time allocated for mixing the fluorophore conjugated molecules with the biological component.

The sample acquiring device may further comprise a sample inlet communicating the measurement cavity with the exterior of the sample acquiring device, said inlet being arranged to acquire a liquid sample. The sample inlet may be arranged to draw up a liquid sample by capillary force and the measurement cavity may further draw liquid from the inlet into the cavity. As a result, the liquid sample may easily be acquired into the measurement cavity by simply moving the sample inlet into contact with the liquid. Then, the capillary forces of the sample inlet and the measurement cavity will draw up a well-defined amount of liquid into the measurement cavity. Alternatively, the liquid sample may be sucked or drawn into the measurement cavity by means of applying an external pumping force to the sample acquiring device. According to another alternative, the liquid sample may be acquired into a pipette and then be introduced into the measurement cavity by means of the pipette.

The sample acquiring device may be disposable, i.e. it is arranged to be used only once. The sample acquiring device provides a kit for performing a count of fluorophore labelled biological components, since the sample acquiring device is able to receive a liquid sample and holds all reagents needed in order to present the sample to counting. This is particularly enabled since the sample acquiring device is adapted for use only once and may be formed without consideration of possibilities to clean the sample acquiring device and re-apply a reagent. Also, the sample acquiring device may be moulded in a plastic material and thereby be manufactured at a low cost. Thus, it may still be cost-effective to use a disposable sample acquiring device.

According to one embodiment of the method for detection of fluorophore labelled biological components in a liquid sample, the sample acquiring device comprises a reagent, which is arranged in a dry form inside the measurement cavity, wherein the reagent comprises a fluorophore conjugated molecule. Then, the mixing is achieved by introducing the liquid sample into the measurement cavity to make contact with the reagent. This implies that there is no need for sample preparation. A reaction may be initiated when the blood sample comes into contact with the reagent. Thus, there is no need for manually preparing the sample, which makes the analysis especially suitable to be performed directly in an examination room while the patient is waiting.

However, according to an alternative embodiment the mixing of the reagent with the liquid sample may be performed before the liquid sample is introduced into the measurement cavity. According to another alternative, mixing may be performed in at least two steps, wherein a first step is performed before the sample is introduced into the measurement cavity and the second step is performed in the measurement cavity. This implies that sample preparation is at least partly made outside the sample acquiring device and that the sample acquiring device. However, the advantage of using a sample acquiring device having a measurement cavity with a fixed thickness is still maintained. Thus, the method provides a possibility to determine the count of biological components per volumetric unit of the liquid sample. Further, there is no need to await that the biological components of interest settle within the measurement cavity or are drawn to an observation surface.

For the irradiation of the sample to be studied it is preferable to use a radiation source arranged not to allow radiation of wavelengths that corresponds to, or are close to, the wavelengths which are emitted by the fluorophores of the sample, to reach the sample, as this would interfere with the detection of the emitted radiation. In order to obtain this limited wavelength radiation a radiation source in conjunction with a chromatic filter is preferably used. Alternatively, a laser which radiates with a specific wavelength that is absorbed by the fluorophore may be used. A prism or a raster (grid) may also be used in order to direct only certain wavelengths of radiation from a radiation source to the sample. The radiation source is preferably a light emitting diode (LED), but any radiation source, such as a laser or a regular light bulb, could be used. A LED is preferred as it is relatively cheap and reliable.

The detection of the fluorophore labelled biological components preferably comprises acquiring a digital image of the irradiated sample in the measurement cavity, wherein biological components exhibiting the fluorophore are distinguished as fluorescing dots emitting electromagnetic radiation of a wavelength corresponding to an emission wavelength of the fluorophore. The digital image is conveniently acquired through the use of a CCD camera incorporated into a fluorescence microscope, the microscope preferably being adapted, conveniently through the use of a chromatic filter, to essentially only allow the wavelength of the electromagnetic radiation emitted by the fluorophore to reach the camera.

The detection of the fluorophore labelled biological components preferably further comprises digitally analysing the digital image for identifying biological components exhibiting the fluorophore and determining the number of biological components exhibiting the fluorophore in the sample. This implies that the detection and/or counting of the biological components may be easily obtained by computer based image analysis. Thus reliable and reproducible results may be obtained.

The liquid sample is preferably introduced into the measurement cavity of the sample acquiring device through a capillary sample inlet by means of capillary force.

The digital image may be acquired using a magnification power of 3-50×, more preferably 3-10×. Within these ranges of magnification power, most biological components, such as mammalian cells, targeted by the present method are sufficiently magnified in order to be detected, while the depth of field may be arranged to cover the sample thickness. A low magnification power implies that a large depth of field may be obtained. However, if a low magnification power is used, the biological components may be hard to detect. A lower magnification power may be used by increasing the number of pixels in the acquired image, that is by improving the resolution of the digital image. In this way, it has been possible to use a magnification power of 3-4×, while still enabling the biological components, such as mammalian cells, to be detected.

The analysing may comprise identifying areas of high emission of electromagnetic radiation, of a specific wavelength corresponding to the emission wavelength of the fluorophore with which the biological component is labelled, in the digital image. The analysing may further comprise identifying light dots in the digital image resulting from specific emitted electromagnetic radiation. Since the fluorophore conjugated molecules may be accumulated around the targeted biological components, the emission of the specific fluorescence may have peaks at separate points. These points will form light dots in the digital image that may be detected as corresponding to a targeted biological component.

The analysing may further comprise electronically magnifying the acquired digital image. While the sample is being magnified for acquiring a magnified digital image of the sample, the acquired digital image itself may be electronically magnified for simplifying distinguishing between objects that are imaged very closely to each other in the acquired digital image.

If two or more different fluorophore conjugated molecules; conjugated to respectively different fluorophores, emitting electromagnetic radiation at respectively different wavelengths, and arranged to bind to respectively different molecular structures; are comprised in the reagent, an image of each emitted wavelength of radiation of the sample may be acquired. These images may then be superimposed, whereby analysis may show some biological components displaying one molecular structure, some others displaying another and some displaying both. If more than two different fluorophore conjugated molecules are used the reasoning is similar.

In yet another embodiment, the present invention relates to a system for volumetric enumeration of fluorophore labelled biological components in a liquid sample, said system comprising a sample acquiring device as defined above; and a measurement apparatus comprising a sample acquiring device holder arranged to receive the sample acquiring device which contains a liquid sample in the measurement cavity, a light source arranged to irradiate the liquid sample with electromagnetic radiation of a predetermined wavelength, an imaging system, comprising a digital image acquiring means for acquiring a digital image of the irradiated sample in the measurement cavity, wherein fluorophore conjugated biological components are distinguished in the digital image by selective electromagnetic wavelength imaging, and an image analyser arranged to analyse the acquired digital image for identifying fluorophore conjugated biological components and determining the number of fluorophore conjugated biological components in the liquid sample.

The measurement apparatus may utilize the properties of the sample acquiring device as described above for making an analysis of a liquid sample that has been directly acquired into the measurement cavity. The measurement apparatus may image a determined volume of the sample for making a volumetric enumeration of biological components in the sample.

### BRIEF DESCRIPTION OF THE DRAWINGS

The invention will now be described in further detail by way of example under reference to the accompanying drawings.

FIG. 1 is a schematic view of a sample acquiring device according to an embodiment of the invention.

FIG. 2 is a schematic view of a sample acquiring device according to another embodiment of the invention.

FIG. 3 is a schematic view of a measurement system according to an embodiment of the invention.

FIG. 4 is a flow chart of a method according to an embodiment of the invention.

### DETAILED DESCRIPTION OF A PREFERRED EMBODIMENT

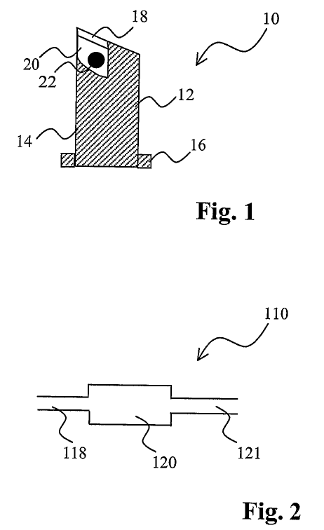

Referring now to FIG. 1, a sample acquiring device 10 according to an embodiment of the invention will be described. The sample acquiring device 10 is disposable and is to be thrown away after having been used for analysis. This implies that the sample acquiring device 10 does not require complicated handling. The sample acquiring device 10 is formed in a plastic material and is manufactured by injection-moulding. This makes manufacture of the sample acquiring device 10 simple and cheap, whereby the cost of the sample acquiring device 10 is kept down.

The sample acquiring device 10 comprises a body member 12, which has a base 14, which may be touched by an operator without causing any interference in analysis results. The base 14 also has projections 16 that fit a holder in an analysis apparatus. The projections 16 are arranged such that the sample acquiring device 10 will be correctly positioned in the analysis apparatus.

The sample acquiring device 10 further comprises a sample inlet 18. The sample inlet 18 is defined between opposite walls within the sample acquiring device 10, the walls being arranged so close to each other that a capillary force is created in the sample inlet 18. The sample inlet 18 communicates with the exterior of the sample acquiring device 10 for allowing blood to be drawn into the sample acquiring device 10. The sample acquiring device 10 further comprises a chamber for counting fluorophore labelled biological components, such as cells, in the form of a measurement cavity 20 arranged between opposite walls inside the sample acquiring device 10. The measurement cavity 20 is arranged in communication with the sample inlet 18. The walls defining the measurement cavity 20 are arranged closer together than the walls of the sample inlet 18, such that a capillary force may draw blood from the sample inlet 18 into the measurement cavity 20.

The walls of the measurement cavity 20 are arranged at a distance from each other of 140 micrometers. The distance is uniform over the entire measurement cavity 20. The thickness of the measurement cavity 20 defines the volume of blood being examined. Since the analysis result is to be compared to the volume of the blood sample being examined, the thickness of the measurement cavity 20 needs to be very accurate, i.e. only very small variations in the thickness are allowed within the measurement cavity 20 and between measurement cavities 20 of different sample acquiring devices 10. The thickness allows a relatively large sample volume to be analysed in a small area of the cavity. The thickness theoretically allows cells to be arranged on top of each other within the measurement cavity 20. However, the amount of cells within a sample, such as a blood sample, is so low that the probability for this to occur is very low.

The sample acquiring device 10 is adapted to measure fluorophore labelled cell counts above 0.5×10⁹ cells/litre blood. At lower cell counts, the sample volume will be too small to allow statistically significant amounts of cells to be counted. Further, when the fluorophore labelled cell count exceeds 12×10⁹ cells/litre blood, the effect of cells being arranged overlapping each other will start to be significant in the measured cell count. At this count of fluorophore labelled cells, the labelled cells will cover approximately 8% of the cross-section of the sample being irradiated when the thickness of the measurement cavity is 140 micrometers. Thus, in order to obtain correct counts of fluorophore labelled cells, this effect will need to be accounted for. Therefore, a statistical correction of values of the labelled cell count above 12×10⁹ labelled cells/litre blood may be used. This statistical correction will be increasing for increasing counts of fluorophore labelled cells, since the effect of overlapping labelled cells will be larger for larger cell counts. The statistical correction may be determined by means of calibration of a measurement apparatus. As an alternative, the statistical correction may be determined at a general level for setting up measurement apparatuses to be used in connection to the sample acquiring device 10. It is contemplated that the sample acquiring device 10 could be used to analyse counts of fluorophore labelled cells as large as 50×10⁹ labelled cells/litre blood.

According to an alternative embodiment, the detection of fluorophore labelled biological components is used for determining whether a specific biological component is present in the sample. In this embodiment, there is no need to perform a volumetric count and, thus, the presence of a biological component may be detected even for very small amounts of the component in the sample.

A surface of a wall of the measurement cavity 20 is at least partly coated with a reagent 22. The reagent 22 may be freeze-dried, heat-dried or vacuum-dried and applied to the surface of the measurement cavity 20. When a sample is acquired into the measurement cavity 20, the sample will make contact with the dried reagent 22 and initiate a binding reaction between the reagent 22 and the sample components.

The reagent 22 is applied by inserting the reagent 22 into the measurement cavity 20 using a pipette or dispenser. The reagent 22 is solved in methanol when inserted into the measurement cavity 20. The solvent with the reagent 22 fills the measurement cavity 20. Then, drying is performed such that the solvent is evaporated and the reagent 22 is attached to the surfaces of the measurement cavity 20.

Since the reagent is to be dried onto a surface of a narrow space, the liquid will have a very small surface in contact with ambient atmosphere, whereby evaporation of the liquid is rendered more difficult. Thus, it is advantageous to use a volatile liquid, such as methanol, which enables the liquid to be evaporated in an effective manner from the narrow space of the measurement cavity.

According to an alternative manufacturing method, the sample acquiring device 10 is formed by attaching two pieces to each other, whereby one piece forms the bottom wall of the measurement cavity 20 and the other piece forms the top wall of the measurement cavity 20. This allows a reagent 22 to be dried onto an open surface before the two pieces are attached to each other. Thus, the reagent 22 may be solved in water, since the solvent need not be volatile.

The reagent 22 may comprise one or more fluorophore conjugated antibodies. The antibodies are adapted to bind to a specific molecular structure characteristic of the targeted biological component, such as a cell. The structure may be a cell surface marker, such as CD4 or CD8. When a blood sample makes contact with the reagent 22, the antibodies will act to bind to the specific molecular structure of the targeted blood cells, thus accumulating at the cells. The reagent 22 should preferably contain sufficient amounts of antibody to distinctly label portions of the targeted cells essentially covering the entire cells. This implies that essentially the entire labelled cells are fluorescent and may thus be easily detected in a digital image of the sample. Further, there will often be a surplus of fluorophore conjugated antibodies, which will be intermixed in the blood plasma. The surplus of antibodies will give a homogenous, low background level of fluorescence in the blood plasma. The accumulated antibodies at the targeted cells will be distinguishable over the background level of fluorescence.

The reagent 22 may also comprise other constituents, which may be active, i.e. taking part in the chemical binding to, e.g., cells of a blood sample, or non-active, i.e. not taking part in the binding. The active constituents may e.g. be arranged to facilitate the binding of the antibodies to their respective target molecular structures. The non-active constituents may e.g. be arranged to improve attachment of the reagent 22 to the surface of a wall of the measurement cavity 20.

Within a few minutes, the blood sample will have reacted with the reagent 22, such that the fluorophore labelled antibodies have bound to the targeted cells.

Referring to FIG. 2, another embodiment of the sample acquiring device will be described. The sample acquiring device 110 comprises a chamber 120 forming the measurement cavity. The sample acquiring device 110 has an inlet 118 into the chamber 120 for transporting blood into the chamber 120. The chamber 120 is connected to a pump (not shown) via a suction tube 121. The pump may apply a suction force in the chamber 120 via the suction tube 121 such that sample is sucked into the chamber 120 through the inlet 118. The sample acquiring device 110 may be disconnected from the pump before measurement is performed. Like the measurement cavity 20 of the sample acquiring device 10 according to the first embodiment, the chamber 120 has a well-defined thickness defining the thickness of the sample to be examined. Further, a reagent 122 is applied to walls of the chamber 120 for reacting with the sample.

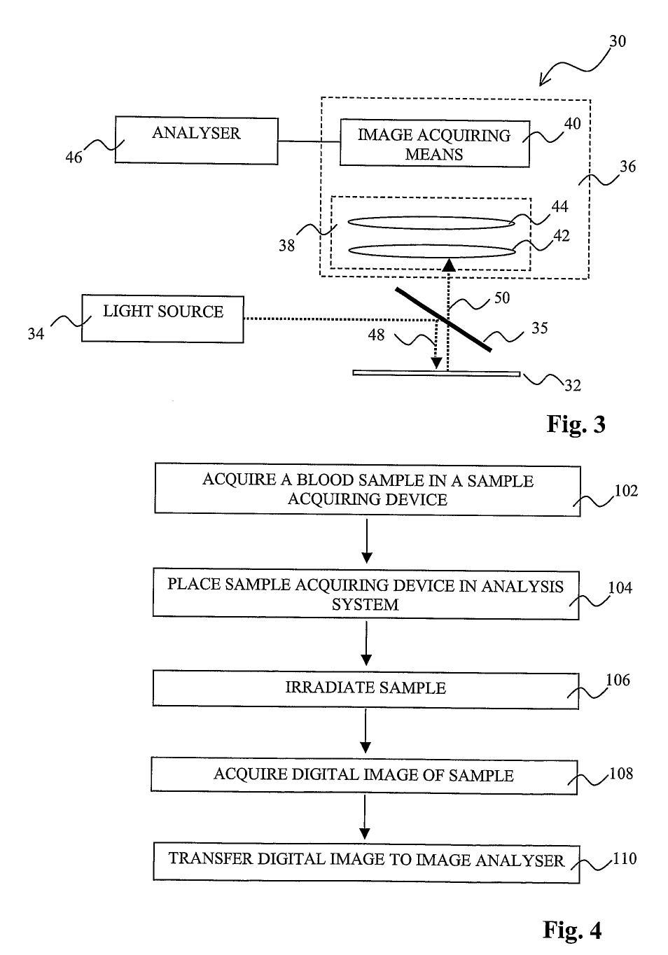

Referring now to FIG. 3, a system for detection and volumetric enumeration of fluorophore labelled biological components will be described. The system 30 comprises a sample holder 32 for receiving a sample acquiring device 10 with a blood sample. The sample holder 32 is arranged to receive the sample acquiring device 10 such that the measurement cavity 20 of the sample acquiring device 10 is correctly positioned within the system 30. The system 30 comprises a light source 34 for illuminating the sample within the sample acquiring device 10. The light source 34 may be a LED, which in conjunction with a chromatic filter irradiates light 48 corresponding to an excitation wavelength of the fluorophore used with the sample. The wavelength should further be chosen such that the absorption of fluorescent compounds of the sample other than the fluorophore labelled components is relatively low. Further, the walls of the sample acquiring device 10 should be essentially transparent to the wavelength. After passing through the chromatic filter, the light is directed to the sample through the use of a dichroic mirror 35. The fluorophores which are accumulated around (or inside) the labelled biological components of the sample, such as cells, will absorb this light 48 of a specific wavelength and emit light 50 of a specific longer wavelength. This emitted light 50 of a longer wavelength is allowed to pass through the dichroic mirror and reach an imaging system 36 such that the components will emerge in a digital image of the sample as light areas or dots. If a colour image is acquired, the labelled cells will emerge as specific coloured dots.

If a black and white image is acquired, the labelled cells will emerge as light dots against a darker background.

The light source 34 may alternatively be an incandescent light in conjunction with a chromatic filter, or a laser.

Alternatively, the light 48 may be directed directly to the sample, at an angle, without the involvement of a dichroic mirror.

The system 30 further comprises an imaging system 36, which is arranged above the sample holder 32. Thus, the imaging system 36 is arranged to receive radiation 50 which has been emitted by the blood sample. The imaging system 36 may comprise an optical magnifying system 38 and an image acquiring means 40. In order to prevent light not emitted by the fluorophores of the sample from reaching the image acquiring means 40, a chromatic filter may be used. The magnifying system 38 may be arranged to provide a magnifying power of 3-50×, more preferably 3-100×, and most preferably 3-4×. Within these ranges of magnifying power, it is possible to distinguish labelled cells. The image may be acquired with an improved resolution in order to allow lower magnifying power to be used. Further, the depth of field of the magnifying system 38 may still be arranged to at least correspond to the thickness of the measurement cavity 20.

The magnifying system 38 may comprise an objective lens or lens system 42, which is arranged close to the sample holder 32, and an ocular lens or lens system 44, which is arranged at a distance from the objective lens 42. The objective lens 42 provides a first magnification of the sample, which is further magnified by the ocular lens 44. The objective lens 42 may be arranged between the dichroic mirror 35 and the sample holder 32. The magnifying system 38 may comprise further lenses for accomplishing an appropriate magnification and imaging of the sample. The magnifying system 38 is arranged such that the sample in the measurement cavity 20 when placed in the sample holder 32 will be focused onto an image plane of the image acquiring means 40.

The image acquiring means 40 is arranged to acquire a digital image of the sample. The image acquiring means 40 may be any kind of digital camera, such as a CCD-camera. The pixel size of the digital camera sets a restriction on the imaging system 36 such that the circle of confusion in the image plane may not exceed the pixel size within the depth of field. However, labelled cells may still be detected even if they are somewhat blurred and, therefore, the circle of confusion may be allowed to exceed the pixel size while being considered within the depth of field. The digital camera 40 will acquire a digital image of the sample in the measurement cavity 20, wherein the entire sample thickness is sufficiently focused in the digital image for counting the labelled blood cells. The imaging system 36 will define an area of the measurement cavity 20, which will be imaged in the digital image. The area being imaged together with the thickness of the measurement cavity 20 defines the volume of the sample being imaged. The imaging system 36 is set up to fit imaging blood samples in sample acquiring devices 10. There is no need to change the set-up of the imaging system 36. Preferably, the imaging system 36 is arranged within a housing such that the set-up is not accidentally changed.

Alternatively, the system 30 may comprise more than one imaging system 36, whereby emitted fluorescence of different wavelengths may be directed to respective different imaging systems. Directing the different wavelengths of light to different imaging systems 36 may be achieved by using e.g. one or more dichroic mirrors or grids.

Also, a plurality of light sources 34 may be used, whereby the sample may be irradiated with light of several different specific wavelengths at the same time or sequentially. This may be achieved by using a plurality of LEDs in conjunction with at least one chromatic filter each. Conveniently all the chromatic filters used within the system 30 may be arranged on wheels, on which all of the most commonly needed chromatic filters may be arranged, such that the specific filter needed for a specific detection may easily be indexed into an active position. A filter is in an active position when it intersects the light from the LED before it reaches the sample, if the filter is used for the excitation light, or when it intersects the fluorescence light from the sample before it reaches the image acquiring means 40, if the filter is used for the emitted light.

The system 30 further comprises an image analyser 46. The image analyser 46 is connected to the digital camera 40 for receiving digital images acquired by the digital camera 40. The image analyser 46 is arranged to identify patterns in the digital image that correspond to a labelled cell for counting the number of labelled cells being present in the digital image. Thus, the image analyser 46 may be arranged to identify light dots against a darker background. The image analyser 46 may be arranged to first electronically magnify the digital image before analysing the digital image. This implies that the image analyser 46 may be able to more easily distinguish labelled cells that are imaged closely to each other, even though the electronic magnifying of the digital image will make the digital image somewhat blurred.

The image analyser 46 may calculate the number of labelled blood cells per volume of blood by dividing the number of labelled blood cells being identified in the digital image with the volume of the blood sample, which is well-defined as described above. The volumetric labelled blood cell count may be presented on a display of the apparatus 30.

The image analyser 46 may be realised as a processing unit, which comprises codes for performing the image analysis.

Referring to FIG. 4, a method of fluorescence labelled biological components will be described. The method will be specifically described with reference to a method for detection and volumetric enumeration of labelled T lymphocytes. However, it will be appreciated by those skilled in the art that the method may be modified for detection and volumetric enumeration of other biological components. A suitable reagent for labelling the biological components of interest need be used, and irradiation and detection need be adapted to the excitation and emission wavelengths of the chosen fluorophores, as will be appreciated by those skilled in the art.

The method for detection and volumetric enumeration of T lymphocytes comprises acquiring a blood sample in a sample acquiring device, step 102, having a fixed thickness of 140 μm. An undiluted sample of human whole blood is acquired in the sample acquiring device. The sample may be acquired from capillary blood or venous blood. A sample of capillary blood may be drawn into the measurement cavity directly from a pricked finger of a patient. The blood sample makes contact with the reagent 22 in the sample acquiring device, initiating a binding reaction. The reagent comprises one Fitc labelled anti CD4 antibody and one APC labelled anti CD8 antibody. Within a few minutes, the blood sample will have reacted with the reagent 22, such that the fluorophore labelled antibodies have bound to the CD4 markers of the T helper lymphocytes and to the CD8 markers of the T killer lymphocytes of the blood sample respectively, and the sample is now ready to be analysed. The sample acquiring device is placed in an analysis apparatus, step 104. An analysis may be initiated by pushing a button of the analysis apparatus. Alternatively, the analysis is automatically initiated by the apparatus detecting the presence of the sample acquiring device.

The sample is irradiated using a LED in conjunction with a chromatic filter arranged to only allow light of about 450 nm to pass, step 106. The allowed light is directed directly at the sample, at a slight angle relative the top surface of the sample acquiring device. The LED light is absorbed by the Fitc fluorophores labelling the CD4+ lymphocytes, whereby the Fitc emits light at around 500 nm. A CCD camera is used to acquire an image of the fluorescent sample without any optical magnification, step 108. The camera is in conjunction with a chromatic filter arranged to allow only light of a wavelength of about 500 nm to pass into the camera. This implies that the digital image will contain light dots/areas in the positions of the labelled T helper cells.

The sample is then again, in the same way as above, irradiated with a LED, now in conjunction with a chromatic filter allowing only light around 590 nm to pass through to the sample, thus exciting the APC fluorophores labelling the CD8+ T killer cells. In analogy with the detection of the Fitc labelled cells a chromatic filter allowing only light around 640 nm to pass on to the CCD camera is used, whereby a second digital image is obtained, this time containing light dots/areas in the positions of the labelled T killer cells present in the sample.

The acquired digital images are transferred to an image analyser, performing an electronic magnification image analysis, step 110, in order to count the number of light dots in the respective digital image. The image analyser is thus capable of determining the concentrations of T helper cells and T killer cells respectively in the blood sample. The image analyser is also capable of superimposing the two images in order to determine if there are any cells that, contrary to expectation, display both CD4 and CD8.

Alternatively, the liquid sample, whole blood in this case, may be reacted, or partly reacted, with the reagent 22 (antibodies) outside of the sample acquiring device 10, after which the reacted, or partly reacted, sample may be acquired in the sample acquiring device 10.

In one embodiment, the reagent 22 comprises a fluorophore labelled secondary antibody, having an affinity for a primary antibody, which secondary antibody is present in the measurement cavity 20 of the sample acquiring device 10 in a dried form. The liquid sample is thus first, outside of the sample acquiring device 10, treated with the primary antibody, which binds to a specific prescribed molecular structure of the targeted biological components of the sample. The sample, including the primary antibodies, is then acquired in the sample acquiring device 10 holding the secondary antibody. The secondary antibodies are thus intermixed with the sample and bind to the primary antibodies, which, in their turn, are bound to the targeted biological components, whereby the targeted biological components are labelled with the fluorophore. This embodiment implies that the dried fluorophore conjugated antibody may be used for labelling many different kinds of biological components, as long as these components have been pre-treated with a primary antibody having an affinity for them. Thus, pre-treatment of the sample allows the sample acquiring device 10 to be used in many different applications and there is no need of adapting the sample acquiring device 10 for use in detection of only one biological component.

It should be emphasized that the preferred embodiments described herein are in no way limiting and that many alternative embodiments are possible within the scope of protection defined by the appended claims.

1. A sample acquiring device for detection of biological components in a liquid sample, said sample acquiring device comprising:
a measurement cavity for receiving a liquid sample, said measurement cavity having a predetermined fixed thickness, and
a reagent, which is arranged in a dry form inside the measurement cavity, said reagent comprising a fluorophore conjugated molecule.

2. The sample acquiring device according to claim 1, wherein the fluorophore conjugated molecule is arranged to bind to a specific molecular structure of a biological component.

3. The sample acquiring device according to claim 1, wherein the sample acquiring device comprises a body member having two planar surfaces which define said measurement cavity.

4. The sample acquiring device according to claim 3, wherein the planar surfaces are arranged at a predetermined distance from one another to determine a sample thickness for an optical measurement.

5. The sample acquiring device according to claim 1, wherein the measurement cavity has a uniform thickness of 50-170 micrometers.

6. The sample acquiring device according to claim 5, wherein the measurement cavity has a uniform thickness of at least 100 micrometers.

7. The sample acquiring device according to claim 5, wherein the measurement cavity has a uniform thickness of no more than 150 micrometers.

8. The sample acquiring device according to claim 1, wherein an area of the measurement cavity is adapted to be imaged in order to provide analysis of a well-defined volume of the sample, whereby volumetric enumeration of a biological component in the sample may be obtained.

9. The sample acquiring device according to claim 1, further comprising a sample inlet communicating the measurement cavity with the exterior of the sample acquiring device, said inlet being arranged to acquire a liquid sample.

10. The sample acquiring device according to claim 9, wherein the inlet is arranged to acquire a liquid sample through capillary force.

11. The sample acquiring device according to claim 1, wherein the reagent has been applied to the surface solved in a volatile liquid which has evaporated to leave the reagent in a dried form.

12. The sample acquiring device according to claim 1, wherein the fluorophore conjugated molecule is an antibody or an antibody fragment.

13. The sample acquiring device according to claim 1, wherein the sample acquiring device is disposable.

14. The sample acquiring device according to claim 1, wherein the reagent is dissolvable and/or suspendable in the liquid sample.

15. A method for detection of fluorophore labelled biological components in a liquid sample, said method comprising:
mixing a reagent comprising a fluorophore conjugated molecule with a liquid sample such that the fluorophore conjugated molecule binds to a specific molecular structure of a biological component in the liquid sample,
introducing the liquid sample into a measurement cavity of a sample acquiring device, said measurement cavity having a predetermined fixed thickness;
irradiating an area of the sample in the measurement cavity with electromagnetic radiation of a wavelength corresponding to an excitation wavelength of the fluorophore; and
detecting fluorophore labelled biological components in the entire thickness of the measurement cavity, said detecting comprising acquiring a digital image of the irradiated area in the measurement cavity.

16. The method according to claim 15, wherein said sample acquiring device comprises a reagent, which is arranged in a dry form inside the measurement cavity, said reagent comprising a fluorophore conjugated molecule, and wherein said mixing is achieved by introducing the liquid sample into the measurement cavity to make contact with the reagent.

17. The method according to claim 15, wherein biological components exhibiting the fluorophore are distinguished in the digital image as fluorescing dots emitting electromagnetic radiation of a wavelength corresponding to an emission wavelength of the fluorophore.

18. The method according to claim 17, wherein the digital image is acquired using an optical magnification power of 3-50×.

19. The method according to claim 17, further comprising:
digitally analysing the digital image for identifying biological components exhibiting the fluorophore and determining the number of biological components exhibiting the fluorophore in the sample.

20. The method according to claim 19, wherein said analysing comprises identifying areas of the digital image resulting from emitted electromagnetic radiation.

21. The method according to claim 19, wherein said analysing comprises identifying dots in the digital image resulting from emitted electromagnetic radiation.

22. The method according to claim 19, wherein said analysing comprises superpositioning two or more obtained images, each image displaying respective specific emitted wavelengths.

23. The method according to claim 19, wherein said analysing comprises electronically magnifying the acquired digital image.

24. The method according to claim 15, wherein the liquid sample is introduced into the measurement cavity of the sample acquiring device through a capillary sample inlet by means of capillary force.

25. The method according to claim 15, wherein said digital image is acquired with a depth of field at least corresponding to the thickness of the measurement cavity.

26. The method according to claim 15, wherein a volume of the analysed liquid sample is well-defined by the thickness of the measurement cavity and an area of the sample being imaged.

27. The method according to claim 15, wherein said irradiating is performed by a light source comprising a light emitting diode,

28. The method according to claim 15, wherein said wavelength corresponding to an excitation wavelength is achieved through the use of a light emitting diode in combination with a chromatic filter.

29. The sample acquiring device according to claim 2, wherein the sample acquiring device comprises a body member having two planar surfaces which define said measurement cavity.

30. The method according to claim 16, wherein biological components exhibiting the fluorophore are distinguished in the digital image as fluorescing dots emitting electromagnetic radiation of a wavelength corresponding to an emission wavelength of the fluorophore.

31. The method according to claim 17, wherein the digital image is acquired using an optical magnification power of 3-10×.

32. The method according to claim 18, further comprising:
digitally analysing the digital image for identifying biological components exhibiting the fluorophore and determining the number of biological components exhibiting the fluorophore in the sample.

33. The method according to claim 20, wherein said analysing comprises identifying dots in the digital image resulting from emitted electromagnetic radiation.
